(19) United States
(12) Patent Application Publication
(10) Pub. No.: US 2025/0225323 A1
(43) Pub. Date: Jul. 10, 2025

(54) SUMMARIZING COMPUTER SYSTEM ALERTS USING GENERATIVE MACHINE LEARNING MODELS

(71) Applicant: Cisco Technology, Inc., San Jose, CA (US)

(72) Inventors: Tian Bu, Basking Ridge, NJ (US); YI HONG, Foster City, CA (US); Robert Wylie Gresham, JR., Mount Pleasant, SC (US); Connor Alan Hollenbeck, Roswell, GA (US); Jesse Stewart Craig-Goodell, Tucker, GA (US); Carlos E. Caballero, Suwanee, GA (US); Ioannis Steiakogiannakis, Marousi (GR); Shirish Shanbhag, Alpharetta, GA (US); Girish Pulprayil Chandranmenon, Edison, NJ (US)

(73) Assignee: Cisco Technology, Inc., San Jose, CA (US)

(21) Appl. No.: 18/605,602

(22) Filed: Mar. 14, 2024

Related U.S. Application Data
(60) Provisional application No. 63/618,492, filed on Jan. 8, 2024.

(51) Int. Cl. G06F 40/284; G06F 16/34

(52) U.S. Cl. CPC G06F 40/284; G06F 16/345

(57) ABSTRACT

Techniques for summarizing a set of alert logs associated with a computer system using a generative machine learning model are described herein. In some cases, an example system receives a set of alert logs, such as logs associated with a detected security incident. The system generates a summarization prompt that includes the set of alert logs, instructions to summarize the logs, and one or more output constraints. The system then provides the summarization prompt to a generative machine learning model M times to determine M summarization outputs. The system determines N of the M summarization prompts that satisfy the output constraint(s) and are thus determined to be valid. The system then determines N scores for the N validated summarization outputs and determines an aggregated summarization output based on a subset of the N summarization outputs as determined based on the corresponding N output scores.

### CROSS-REFERENCES TO RELATED APPLICATION(S)

This patent application claims priority to and the benefit of U.S. Provisional Patent Application No. 63/618,492, filed on Jan. 8, 2024 and entitled “Auto-Generation of Natural Language Descriptions and Summaries of Security Incidents,” which is incorporated by reference herein in its entirety and for all purposes.

### TECHNICAL FIELD

This present application pertains to the field of computer security and more specifically, to techniques for summarizing alerts associated with monitored computer systems using generative machine learning models.

### BACKGROUND

Security monitoring systems may integrate data from the entire information technology infrastructure of a computing system to provide unified visibility and automated actions against cyberattacks. A core challenge in these systems is summarizing data associated with monitoring of one or more computer systems.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts an example environment with an Extended Detection and Response (XDR) system.

FIG. 2 is a flowchart diagram of an example process for summarizing a set of alert logs.

FIG. 3 provides an operational example of determining a summarization prompt 308.

FIG. 4 is a flowchart diagram of an example process for determining whether to validate a summarization output generated by a generative machine learning model.

FIG. 5 is a flowchart diagram of an example process for determining an aggregated summarization output based on a set of validated summarization outputs.

FIG. 6 shows an example computer architecture for a computing device capable of executing program components for implementing the functionality described above.

### DESCRIPTION OF EXAMPLE EMBODIMENTS

### Overview

Techniques for summarizing a set of alert logs associated with a computer system using a generative machine learning model are described herein. In some cases, the techniques described herein relate to a method including receiving, by a processor, a first alert log and a second alert log associated with a security incident, wherein the first alert log is associated with a first alert group and the second alert log is associated with a second alert group, and wherein the security incident is associated with a computer system; determining, by the processor and based on the first alert log and the second alert log, a first prompt, wherein the first prompt comprises text data requesting summarization of the first alert log and the second alert log; determining, by the processor and based on the first alert group and the second alert group, a first count of alert groups associated with the first prompt; providing, by the processor, the first prompt to a generative machine learning model; receiving, by the processor, a first model output from the generative machine learning model; determining, by the processor and based on the first model output, a second count of alert groups associated with the first model output; determining, by the processor and based on the first count and the second count, that the first model output is valid; based on determining that the first model output is valid, determining, by the processor, a summary based on the first model output; and providing, by the processor, the summary using an output interface.

Additionally, the techniques described herein may be performed by a system and/or device having non-transitory computer-readable media storing computer-executable instructions that, when executed by one or more processors, performs the method described above.

### Example Embodiments

Techniques for summarizing a set of alert logs associated with a computer system using a generative machine learning model are described herein. In some cases, an example system receives a set of alert logs, such as logs associated with a detected security incident. The system generates a summarization prompt that includes the set of alert logs, instructions to summarize the logs, and one or more output constraints. The system then uses the generative machine learning model to generate M summarization outputs (e.g., provides the summarization prompt to a generative machine learning model M times to determine M summarization outputs; provides the summarization to the model less than M times, such as once, to determine M summarization outputs based on the output(s) generated by the model; and/or the like). The system determines N of the M summarization prompts that satisfy the output constraint(s) and are thus determined to be valid. The system then determines N scores for the N validated summarization outputs and determines an aggregated summarization output based on a subset of the N summarization outputs as determined based on (e.g., defined by) the corresponding N output scores.

In some cases, the techniques described herein include receiving a set of alert logs. The system may receive a set of alert logs that are deemed to be related to a detected system incident or that occur within a period that includes an incident time. For example, the system can receive logs associated with an ongoing malware attack detected on 3 endpoints within a short span of a few hours. The alert logs represent structured data about alerts from various monitoring components in the network, such as intrusion detection systems, firewalls, endpoint security solutions etc. These components generate alerts when suspicious events or violations of security policies occur.

In some cases, the techniques described herein include generating a summarization prompt based on the received alert logs. The summarization prompt includes the set of alert logs, a request to summarize the logs, and output constraints such as conciseness, correctness, structural, and completeness constraints. For example, a conciseness constraint may require that the summarization's overview section does not exceed one hundred words. A completeness constraint may require listing all the affected hostnames detected in the input logs. These constraints are used to evaluate the summarization output against expected quality criteria.

In some cases, the techniques described herein include providing the summarization prompt to a generative machine learning model multiple times. The generative model uses attention-based encoding and decoding to generate natural language summarization outputs that reflect an understanding of the input logs and follow the constraints. For example, the model encoder maps input log details to an abstract representation, and the decoder translates that representation into coherent summarization text. The prompt is provided M times, such as ten times, to cause the model to generate M candidate summarization outputs with variation.

In some cases, the techniques described herein include determining which of the M summarization outputs are valid. The system evaluates each output to determine if it satisfies the constraints specified in the original prompt. Structural, completeness, conciseness and correctness constraints are checked for each output. If an output meets the conditions, such as having the required overview section length, it is considered a valid summarization. N of M outputs may be determined to be valid in this manner, such as 5 valid outputs out of 10 candidates.

In some cases, the techniques described herein include determining scores for the N valid summarization outputs. Scoring metrics like output length, number of alert groups covered, and number of IP addresses (e.g., or other network addresses) mentioned are used to quantify summarization quality and usefulness. For example, outputs that describe more salient alert groups or contain more relevant technical details may receive higher scores. Each valid output gets an individual score reflecting its informational coverage and fidelity.

In some cases, the techniques described herein include generating an aggregated output based on the N scores. The system may select the top R scored outputs such as the top 3 outputs or outputs above a threshold T score such as 8 out of 10 to include in the final aggregated summarization presented to the user. This output combines the highest quality information extracted from the logs for concise and comprehensive incident understanding. Adding representative examples to the selected outputs can further enrich the final summary.

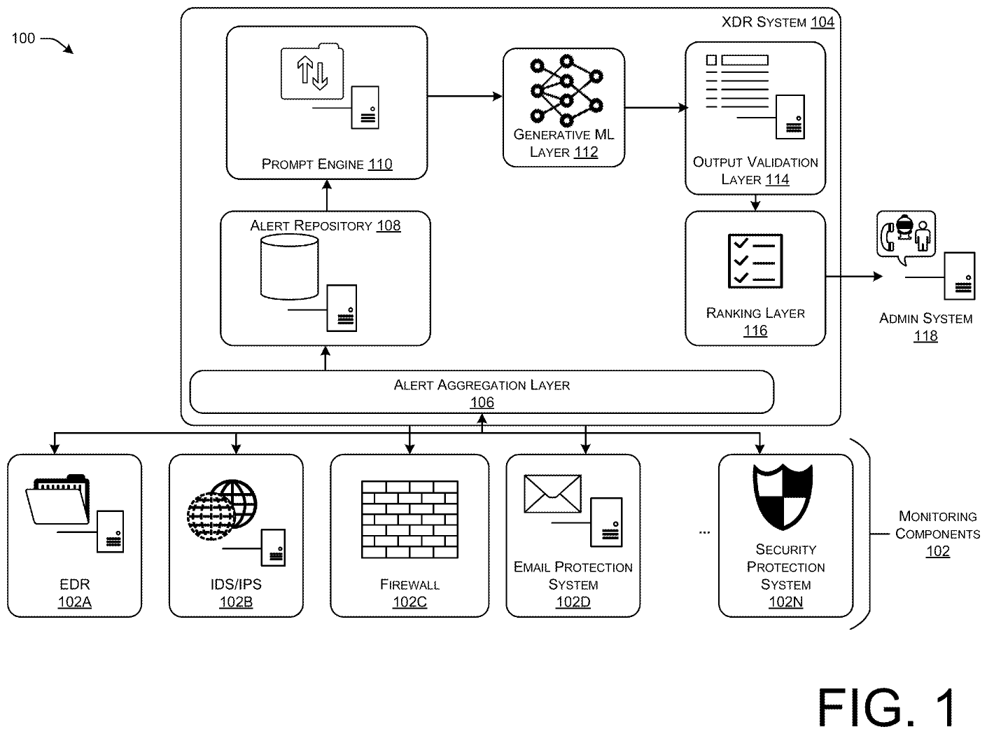

FIG. 1 depicts an example environment 100 with an Extended Detection and Response (XDR) system 104 that interacts with a set of monitoring components 102, such as an EDR system 102A, an Intrusion Detection System (IDS)/Intrusion Prevention System (IPS) 102B, a firewall engine 102C, an email protection system 102D, and other security protection systems 102N. The monitoring components 102 may be configured to generate alert log(s) corresponding to monitoring alert(s) (e.g., monitoring alerts describing security deficiencies associated with a computer network) and provide the generated monitoring alert(s) to the XDR system 104, as further described below. While various implementations of the techniques described herein are described as being performed by an XDR system, a person of ordinary skill in the relevant technology will recognize that the disclosed techniques may be implemented by other computer security frameworks as well. In some cases, the techniques are implemented by a system for processing CVE data and/or text data indexed based on CVE identifiers.

The EDR system 102A may monitor activity on endpoints such as servers, desktops, and laptops. The EDR system 102A may generate monitoring alert logs for suspicious or malicious activity observed on endpoints. The EDR system 102A may be implemented as agent software installed on each endpoint. The agent software may operate in the background by continuously collecting endpoint telemetry data and sending it to a central management console and/or the XDR system 104. The EDR agent may employ various techniques to detect threats, such as signature-based detection, behavioral analysis, and machine learning algorithms. Signature-based detection may include comparing observed activities against known patterns of malicious behavior or attack signatures. Behavioral analysis may include identifying anomalies and/or deviations from normal endpoint behavior which might indicate a potential threat. Additionally, machine learning algorithms may enhance detection capabilities by learning from historical data and adapting to new and emerging threats.

The IDS/IPS 102B may monitor network activity by analyzing network traffic. The IDS/IPS 102B may generate monitoring alert logs for anomalous network traffic and/or known attack patterns. To perform monitoring and detection operation, the IDS/IPS 102B may employ a combination of techniques, including signature-based detection, anomaly detection, and heuristic analysis. Signature-based detection may include comparing network traffic against a database of known attack patterns. Anomaly detection may include identifying deviations from normal network behavior, which could indicate possible intrusions and/or suspicious activities. Heuristic analysis may include applying predefined rules and behavioral models to detect threats. In some cases, the IDS/IPS 102B performs at least one of an IDS or an IPS functionality. The IDS functionality may identify suspicious or anomalous network behaviors, such as port scans, unusual data transfer patterns, and/or unauthorized access attempts. The IPS functionality may perform immediate action(s) to block or prevent identified threats from progressing further into the network. The IDS/IPS 102B may be implemented as a hardware or virtual network appliance deployed on the network. For example, the IDS/IPS 102B may be implemented as a hardware appliance installed at strategic points within the network infrastructure. Alternatively, the IDS/IPS 102B may be implemented as a virtual network appliance running on virtualized servers or cloud-based instances.

The firewall engine 102C may filter incoming and outgoing network traffic according to configured rules. The firewall engine 102C may generate monitoring alert logs when traffic is blocked or allowed. In some cases, the firewall engine 102C operates as a barrier between an internal network and an external network by controlling the flow of network traffic based on predefined rules. In some cases, the firewall engine 102C is configured to filter incoming and outgoing network traffic to enforce security policies and protect a network's assets from unauthorized access.

In some cases, when network packets are received at the firewall engine 102C, the received network packets are inspected against a set of predefined rules. These rules can be based on various criteria, such as source and destination IP addresses, port numbers, application protocols, or specific content within the packets. If a packet matches a rule for allowing network traffic, the firewall engine 102C may permit passage of the allowed packet through to the intended destination. On the other hand, if the packet matches a rule for denying network traffic, the firewall engine 102C may block the passage of the packet to prevent unauthorized access and/or to prevent potentially malicious traffic from entering and/or leaving the network. The firewall engine 102C may be implemented as a hardware and/or virtual network appliance.

The email protection system 102D may scan incoming and outgoing emails for malware and spam. The email protection system 102D may generate monitoring alert logs for blocked and/or allowed emails. The email protection system 102D may be implemented as a software service integrated with email servers. In some cases, the email protection system 102D continually evaluates the content, attachments, and/or sender reputation of incoming emails. To do so, the email protection system 102D may use databases of known threat patterns to identify and block emails that exhibit malicious behavior and/or contain harmful content. In some cases, the email protection system 102D processes outgoing emails to ensure that those outgoing emails do not inadvertently transmit sensitive information and/or include suspicious links and/or attachments. In some cases, whenever the email protection system 102D identifies a potentially malicious or spam email, the email protection system 102D generates one or more monitoring alert logs to record the identification. These monitoring alert logs can include details such as the sender's information, recipient details, timestamp, and/or a description of the threat and/or spam category.

Additional security protection systems 102N may perform other types of security monitoring and generate associated monitoring alert logs. Examples of such additional security protection systems 102N include Web Application Firewalls (WAFs), Data Loss Prevention (DLP) systems, Network Access Control (NAC) systems, threat intelligence platforms, advanced threat detection systems, Security Information and Alert Management (SIEM) systems, vulnerability management systems, and Endpoint Protection Platforms (EPPs).

As depicted in FIG. 1, an alert aggregation layer 106 receives the monitoring alert logs generated by the monitoring components 102 and stores those alert logs on an alert repository 108. The alert repository 108 may be a storage framework for collecting, storing, and/or analyzing the monitoring alert logs generated by the various monitoring components 102. The alert repository 108 may receive the monitoring alert logs in real-time from the monitoring components 102 and the received alert logs in a structured and/or semi-structured format for efficient retrieval and/or analysis. The alert repository 108 may be implemented using a database, data warehouse, and/or cloud storage. If implemented as a database, the alert repository 108 may utilize NoSQL databases like Apache Cassandra or MongoDB to provide horizontal scaling capabilities to handle large volumes of data. If implemented as a data warehouse, the alert repository 108 may use solutions like Amazon Redshift or Google BigQuery to enable complex analytics and/or reporting on historical data. If implemented as a cloud storage solution, the alert repository 108 may use cloud-based object storage services like Amazon S3 or Microsoft Azure Blob Storage.

The alert aggregation layer 106 may, for example, receive the monitoring alert logs in real-time from the monitoring components 102, transform the monitoring alert logs into a unified format, and/or store the monitoring alert logs and/or reformatted monitoring alert logs in the alert repository 108. The alert aggregation layer 106 may store data determined based on the monitoring alert logs using a structured and/or a semi-structured format. The alert repository 108 may, in some cases, be configured to receive and store the monitoring alert logs generated by the monitoring components 102.

In some cases, an alert is alert is a notification generated by a monitoring component when a suspicious event or activity is detected. For example, an intrusion detection system may raise an alert if it identifies malicious network traffic trying to access sensitive ports on a server. Similarly, an endpoint detection and response solution may generate an alert if suspicious file or process activities are observed on an endpoint. In some cases, an alert log refers to the record created to document the details of an alert. Alert logs typically include fields such as the timestamp, monitoring component name, affected asset, alert severity, event category, and a description of the suspicious activity. By centralizing these alert logs in the alert repository, security teams can gain visibility into threats and anomalies detected across the environment. In some cases, related alerts may be grouped together into an alert group. An alert group connects alerts that are likely part of an ongoing attack campaign or a broader security incident. For example, if alerts for malicious file execution, lateral movement, and data exfiltration are detected from the same endpoint, these alerts may be grouped as part of the same incident investigation. Alert grouping enables faster incident response by correlating alerts that are tactically or strategically related. Security teams can prioritize and investigate alert groups rather than individual alerts.

In some cases, a prompt engine 110 retrieves alert logs from the alert repository 108 and generates a prompt requesting that a generative machine learning model summarizes the alert logs. For example, the prompt engine 110 may retrieve alert logs that are deemed to be related to a detected system incident and provide the retrieved logs as part of a summarization prompt that is provided to a generative machine learning model. As another example, the prompt engine 110 may retrieve alert logs that occur within a period that includes a detected incident time and/or in relation to a system component (e.g., an endpoint device) affected by a detected incident, and provide these retrieved logs as part of a summarization prompt that is provided to the generative machine learning model.

In some cases, a summarization prompt specifies one or more constraints that are used to evaluate the corresponding output of the generative machine learning model. For example, the summarization prompt may specify one or more structural constraints. A structural constraint may specify one or more segments associated with the model output and/or one or more attributes (e.g., one or more length attributes and/or one or more word-count attributes) associated with at least one specified output segment. For example, a structural constraint may require that a summarization output have a certain structure, such as including a title, an introductory paragraph, one or more paragraphs summarizing key details about alert groups, and a concluding paragraph. As another example, a structural constraint may require that the summarization output should start with a title that has no more than 15 words. As another example, a structural constraint may require that the summarization output have a first paragraph that is labeled as being an overview paragraph and should have no more than 100 words. As another example, a structural constraint may require that the summarization output have a set of paragraphs (e.g., a set of paragraphs after the opening paragraph) that include detailed discussion of alert groups associated with those alert logs included in the prompt. As another example, a structural constraint may require that all time values are written in the YYYY-MM-DD HH:MM:SS format in the summarization output.

In some cases, the summarization prompt may specify one or more completeness constraint. A completeness constraint may require that a summarization output specifies a set of values and that those sets of values correspond to ground-truth data associated with the alert logs included in the summarization prompt. For example, the alert logs included in the summarization prompt may be associated with a set of alert groups, and a completeness constraint may require that the summarization output lists the set of alert groups. As another example, a completeness constraint require that, for each alert group associated with the alert logs included in the summarization prompt, the summarization output specifies at least one of: the number of (e.g., count of) alerts whose logs are included in the summarization prompt and are associated with the particular alert group, the starting time(s) associated with those alerts whose logs are included in the summarization prompt and are associated with the particular alert group, the host(s) associated with those alerts whose logs are included in the summarization prompt and are associated with the particular alert group, the process(es) associated with those alerts whose logs are included in the summarization prompt and are associated with the particular alert group, the IP address(es) associated with those alerts whose logs are included in the summarization prompt and are associated with the particular alert group, the director (ies) associated with those alerts whose logs are included in the summarization prompt and are associated with the particular alert group, the device(s) associated with those alerts whose logs are included in the summarization prompt and are associated with the particular alert group, the suspicious external IP address(es) associated with those alerts whose logs are included in the summarization prompt and are associated with the particular alert group, the suspicious hostname(s) associated with those alerts whose logs are included in the summarization prompt and are associated with the particular alert group, the suspicious internal IP address(es) associated with those alerts whose logs are included in the summarization prompt and are associated with the particular alert group, and/or the like.

In some cases, the summarization prompt may specify one or more conciseness constraints. A conciseness constraint may specify one or more desired length-related attributes for one or more segments of a summarization output. For example, a conciseness constraint may require that the title of the summarization output is shorter than forty-five characters. As another example, a conciseness constraint may require that the summarization output uses less than fifty words and/or tokens for describing each alert group. As another example, a conciseness constraint may require that a segment of the summarization output that relates to the particular alert group does not include more than two paragraphs. As another example, a conciseness constraint may require that the summarization output's introduction section does not exceed one-hundred words and/or tokens in length. In some cases, conciseness constraints may set upper limits on the permissible length of the entire summarization content or individual sections covering distinct facets of the security incident documented across the alert logs. For example, a conciseness constraint may confine the section outlining attacker tactics inferred from sequences of alerts to 150 words and/or tokens.

In some cases, the summarization prompt may specify one or more correctness constraint. A correctness constraint may specify one or more accuracy-related desired attributes. For example, a correctness constraint may require that the total number of alert groups described by the summarization output matches the total number of alert groups associated with those alert logs that are included in the summarization prompt. As another example, a correctness constraint may require that, for each alert group associated with the alert logs included in the summarization prompt, the summarization output specifies the correct number of alerts whose logs are included in the summarization prompt and are associated with the particular alert group.

In some cases, the prompt engine 110 generates a summarization prompt associated with a set of alert logs using a prompt template. The prompt template may specify that the prompt relates to summarizing a set of alert logs and includes a set of output constraints. For example, the prompt template may include the following text: “as a security analyst, review the security incident which triggered multiple groups of alerts below delimited by triple backticks and draft a report that describes what happened and show the progression in a timeline according to starting times of alert groups. Requirements include:”. In addition to retrieving and using a prompt template, the prompt engine 110 may retrieve a set of output constraints. The set of output constraints may be determined based on user input (e.g., may be specified by a user) and/or may be automatically determined based on one or more attributes of the set of alert logs (e.g., an incident type associated with the set of alert logs). For example, for a security incident categorized as involving ransomware activity, the prompt engine 110 may automatically select a predefined set of output constraints specific to ransomware cases. These output constraints may require that a summarization output specifically covers details such as affected hosts, number of encrypted files, ransom note contents, the ransom demanded, external communication indicators, and adopted mitigation steps. In some cases, to determine a summarization prompt, the prompt engine 110 combines: (i) a prompt template, (ii) a set of output constraints, and (iii) a set of alert logs.

In some cases, after the prompt engine 110 generates a summarization prompt, the prompt engine 110 provides the summarization prompt to the generative machine learning layer 112. The generative machine learning layer 112 may process the summarization prompt using a generative machine learning model, such as a large language model, to determine a summarization output and provide the summarization output to the output validation layer 114. The generative machine learning model may be a model that is configured to generate natural language text reflecting a semantic understanding of input text data as guided by the summarization instruction(s) and/or the output constraint(s) described in the input summarization prompt. For example, the generative machine learning model may use an attention-based encoder to generate an encoded representation of the input text prompt and a decoder to process the encoded representation to generate the output text.

The generative machine learning model may be trained using an auto-regressive approach, for example using techniques such as missing word prediction or next word prediction. In some cases, the generative machine learning model is trained and/or fine-tuned in a supervised manner. For example, the generative machine learning model may be fine-tuned on a dataset of text labelled with structured annotations reflecting ground-truth summarizations. In some cases, the generative machine learning model is fine-tuned using Reinforcement learning from Human Feedback (RLHF), for example using a reward model that is trained to predict human feedback based on the output of the generative machine learning model.

After the generative machine learning layer 112 processes a summarization prompt using a generative machine learning model to generate a corresponding summarization output, the generative machine learning layer 112 provides the generated summarization output to the output validation layer 114. The output validation layer 114 may be configured to determine whether the summarization output satisfies one or more conditions specified by the one or more output constraints specified in the summarization prompt. If the summarization output satisfies the condition(s) specified by the output constraint(s), the output validation layer 114 may determine that the summarization output is valid. Otherwise, if the summarization output fails to satisfy the condition(s) specified by the output constraint(s), the output validation layer 114 may determine that the summarization output is invalid.

In some cases, the generative machine learning layer 112 provides a summarization prompt to the generative machine learning model M times to generate M corresponding summarization outputs. After the generative machine learning layer 112 generates the M summarization outputs by processing the summarization prompt M times, the output validation layer 114 may determine N of those M summarization outputs that satisfy the output constraints. For example, the output validation layer 114 may reject those summarization outputs that fail to satisfy structural constraints, completeness constraints, conciseness constraints, and/or correctness constraints. After the output validation layer 114 determines N validated summarization outputs, the ranking layer 116 generates N corresponding scores for those N summarization outputs. The ranking layer 116 may then provide an output to a client system 118 based on a subset of the N summarization outputs as determined based on the N corresponding scores. For example, the ranking layer 116 may provide an output determined based on the R outputs having the top R voting scores, where R may be a hyperparameter of the ranking layer 116. As another example, the ranking layer 116 may provide an output determined based on the summarization outputs whose voting scores exceed a threshold T, where T may be a hyperparameter of the ranking layer 116.

In some cases, the ranking layer 116 determines a score associated with a summarization output based on one or more scoring metrics associated with the summarization output. For example, the ranking layer 116 may determine the score associated with the summarization output based on a length-related metric (e.g., a number of tokens and/or words) associated with the summarization output.

As another example, the ranking layer 116 may determine the score associated with the summarization output based on a metric determined based on a number of alert groups specified in the summarization output (e.g., a ratio of the number of alert groups specified in the output to the number of alert groups associated with the alert logs included in the prompt, a deviation between number of alert groups specified in the output and the number of alert groups associated with the alert logs included in the prompt, and/or the like).

As another example, the ranking layer 116 may determine the score associated with the summarization output based on a number of hostnames specified in the summarization output (e.g., a ratio of the number of hostnames specified in the output to the number of hostnames associated with the alert logs included in the prompt, a deviation between number of hostnames specified in the output and the number of hostnames associated with the alert logs included in the prompt, and/or the like).

As another example, the ranking layer 116 may determine the score associated with the summarization output based on a number of external IP addresses specified in the summarization output (e.g., a ratio of the number of external IP addresses specified in the output to the number of external IP addresses associated with the alert logs included in the prompt, a deviation between number of external IP addresses specified in the output and the number of external IP addresses associated with the alert logs included in the prompt, and/or the like).

As another example, the ranking layer 116 may determine the score associated with the summarization output based on a number of internal IP addresses specified in the summarization output (e.g., a ratio of the number of internal IP addresses specified in the output to the number of internal IP addresses associated with the alert logs included in the prompt, a deviation between number of internal IP addresses specified in the output and the number of internal IP addresses associated with the alert logs included in the prompt, and/or the like).

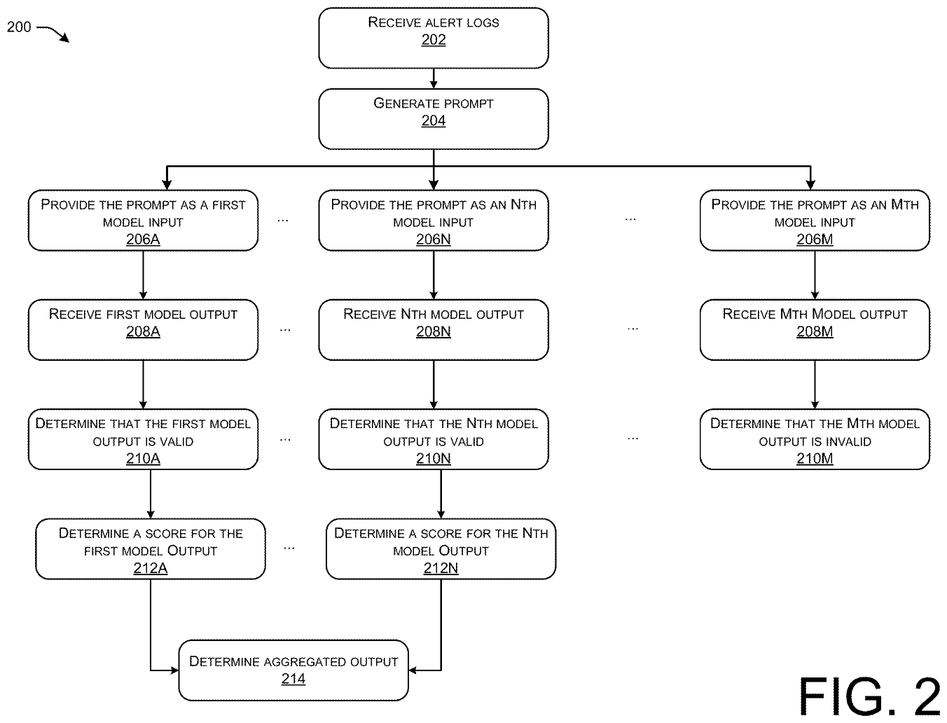

FIG. 2 is a flowchart diagram of an example process 200 for summarizing a set of alert logs. As depicted in FIG. 2, at operation 202, an example system receives a set of alert logs. For example, the system may receive a set of alert logs that are deemed to be related to a detected system incident. As another example, the system may receive a set of alert logs that occur within a period that includes a detected incident time and/or in relation to a system component (e.g., an endpoint device) affected by a detected incident.

At operation 204, the system generates a summarization prompt based on the received alert log(s). In some cases, the summarization prompt includes: (i) the set of alert log(s), (ii) a summarization prompt requesting summarization of the alert log(s), and (iii) a set of output constraints. In some cases, a summarization prompt specifies one or more constraints that are used to evaluate the corresponding output of the generative machine learning model. For example, the summarization prompt may specify a set of conciseness constraints, correctness constraints, structural constraints, and/or completeness constraints.

At operations 20A-206M, the system provides the summarization prompt to a generative machine learning model M times. For example, at operation 206A, the system provides the summarization prompt to the generative machine learning model as a first model input; at operation 206N, the system provides the summarization prompt to the generative machine learning model as an Nth model input; and at operation 206M, the system provides the summarization prompt to the generative machine learning model as an Mth model input.

The generative machine learning model may be a model that is configured to generate natural language text reflecting a semantic understanding of input text data as guided by the summarization instruction(s) and/or the output constraint(s) described in the input summarization prompt. For example, the generative machine learning model may use an attention-based encoder to generate an encoded representation of the input text prompt and a decoder to process the encoded representation to generate the output text.

At operations 208A-208M, the system receives M summarization outputs from the generative machine learning model. For example, at operation 208A, the system receives a first summarization output from the generative machine learning model; at operation 208N, the system receives an Nth summarization output from the generative machine learning model; and at operation 208M, the system receives an Mth summarization output from the generative machine learning model.

At operations 210A-210M, the system determines that N of the M summarization outputs are valid, while M-N of the M summarization outputs are invalid. For example, at operation 210A, the system determines that a first summarization output received from the generative machine learning model is valid; at operation 210N, the system determines that an Nth summarization output received from the generative machine learning model is valid; and at operation 210M, the system determines that an Mth summarization output received from the generative machine learning model is valid. In some cases, to determine whether a summarization output is valid, the system may be configured to determine whether the summarization output satisfies one or more conditions specified by the one or more output constraints specified in the summarization prompt. If the summarization output satisfies the condition(s) specified by the output constraint(s), the system may determine that the summarization output is valid. Otherwise, if the summarization output fails to satisfy the condition(s) specified by the output constraint(s), the system may determine that the summarization output is invalid.

At operations 212A-212N, the system determines a score for each of the N validated summarization outputs. For example, at operation 212A, the system determines a first score for the first summarization output; and at operation 212N, the system determines an Nth score for an Nth summarization output. In some cases, to determine a score for a summarization output, the summarization uses one or more scoring metrics associated with the summarization output.

For example, the system may determine the score associated with the summarization output based on a length-related metric (e.g., a number of tokens and/or words) associated with the summarization output. As another example, the system may determine the score associated with the summarization output based on a metric determined based on a number of alert groups specified in the summarization output (e.g., a ratio of the number of alert groups specified in the output to the number of alert groups associated with the alert logs included in the prompt, a deviation between number of alert groups specified in the output and the number of alert groups associated with the alert logs included in the prompt, and/or the like).

At operation 214, the system determines an aggregated output based on the N scores associated with the N validated summarization outputs. For example, the aggregated output may describe the R outputs having the top R voting scores, where R may be a hyperparameter of the system. As another example, the aggregated output may describe the summarization outputs whose voting scores exceed a threshold T, where T may be a hyperparameter of the system.

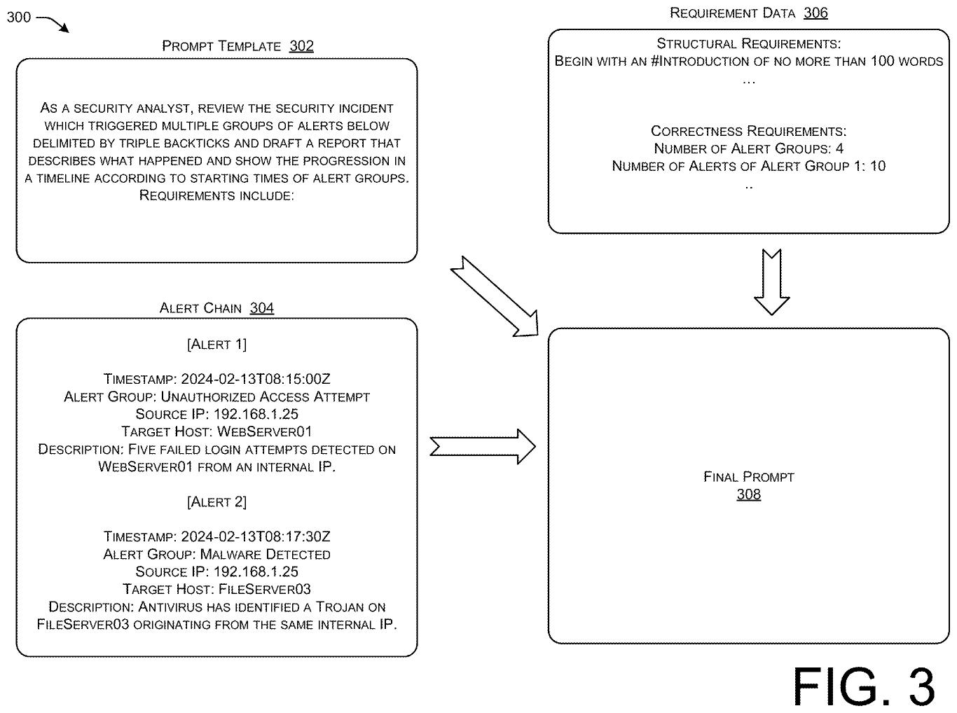

FIG. 3 provides an operational example 300 of determining a summarization prompt 308. As depicted in FIG. 3, the summarization prompt 308 is determined based on (e.g., includes): (i) a prompt template 302, (ii) an alert chain 304 describing a set of alert logs that are to be summarized, and (iii) requirement data 306 describing one or more output constraints. For example, the requirement data 306 may specify a set of conciseness constraints, correctness constraints, structural constraints, and/or completeness constraints.

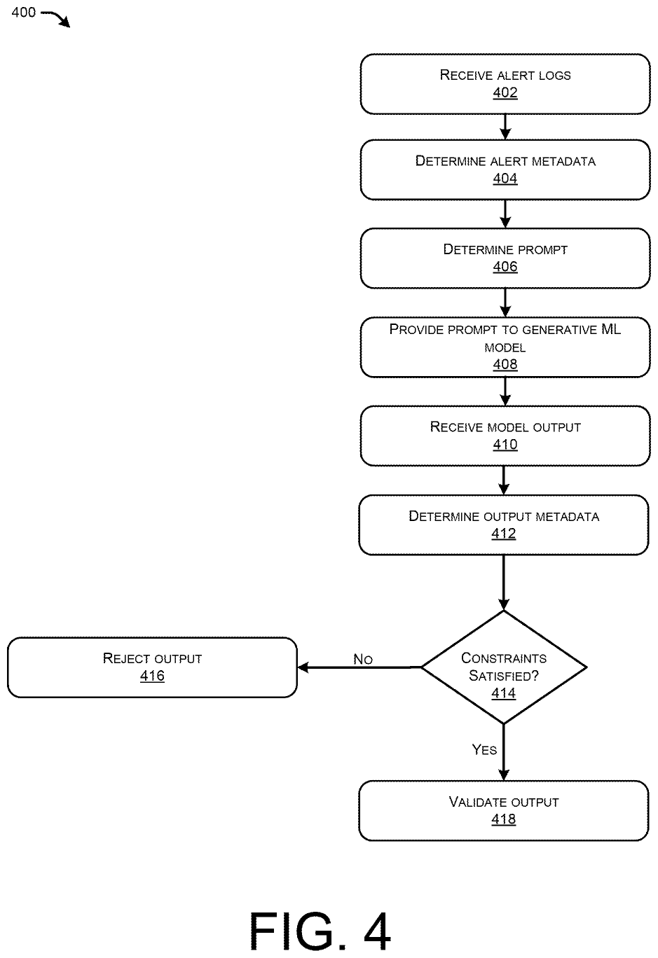

FIG. 4 is a flowchart diagram of an example process 400 for determining whether to validate a summarization output generated by a generative machine learning model. As depicted in FIG. 4, at operation 402, the system receives a set of alert logs. The alert logs may represent structured data about one or more alerts associated with a monitored software system and/or a detected system incident.

At operation 404, the system determines a set of metadata values about the alert logs. The metadata values may be used to determine whether the summarization output corresponding to the alert logs satisfies one or more completeness and/or one or more correctness constraints.

Examples of metadata values determined based on a set of alert logs include a number of alert groups associated with the set of alert logs, a number of alerts associated with each of the alert groups associated with the set of alert logs, identifiers of the alert groups associated with the set of alert logs, a number of hostnames associated with the set of alert logs, identifiers of the hostnames associated with the set of alert logs, a number of internal IP addresses associated with the set of alert logs, identifiers of the internal IP addresses associated with the set of alert logs, a number of external IP addresses associated with the set of alert logs, identifiers of the external IP addresses associated with the set of alert logs, and/or the like.

At operation 406, the system determines a summarization prompt based on the alert logs. The summarization prompt may include a prompt template text, a set of output constraints determined based at least in part on the metadata values, and the set of alert logs. In some cases, the summarization prompt may specify a set of conciseness constraints, correctness constraints, structural constraints, and/or completeness constraints.

At operation 408, the system provides the summarization prompt to a generative machine learning model. The generative machine learning model may be a model that is configured to generate natural language text reflecting a semantic understanding of input text data as guided by the summarization instruction(s) and/or the output constraint(s) described in the input summarization prompt. For example, the generative machine learning model may use an attention-based encoder to generate an encoded representation of the input text prompt and a decoder to process the encoded representation to generate the output text.

At operation 410, the system receives a model output from the generative machine learning model. The model output may be generated by the generative machine learning model via processing the summarization prompt.

At operation 412, the system determines a set of metadata values described by the summarization output. Examples of metadata values described by a summarization output include a number of alert groups described by the summarization output, a number of alerts associated with each of the alert groups described by the summarization output, identifiers of the alert groups described by the summarization output, a number of hostnames described by the summarization output, identifiers of the hostnames described by the summarization output, a number of internal IP addresses described by the summarization output, identifiers of the internal IP addresses described by the summarization output, a number of external IP addresses described by the summarization output, identifiers of the external IP addresses described by the summarization output, and/or the like.

At operation 414, the system determines whether a set of output constraints are satisfied by the summarization output. The set of output constraints may include one or more constraints determined based on whether the set of metadata values associated with the alert logs match the set of metadata values described by the summarization output. If the system determines that the summarization output fails to satisfy the output constraint(s) (operation 414 —No), the system proceeds to operation 416 to reject the summarization output. However, if the system determines that the summarization output satisfies the output constraint(s) (operation 414—Yes), the system proceeds to operation 418 to validate the summarization output.

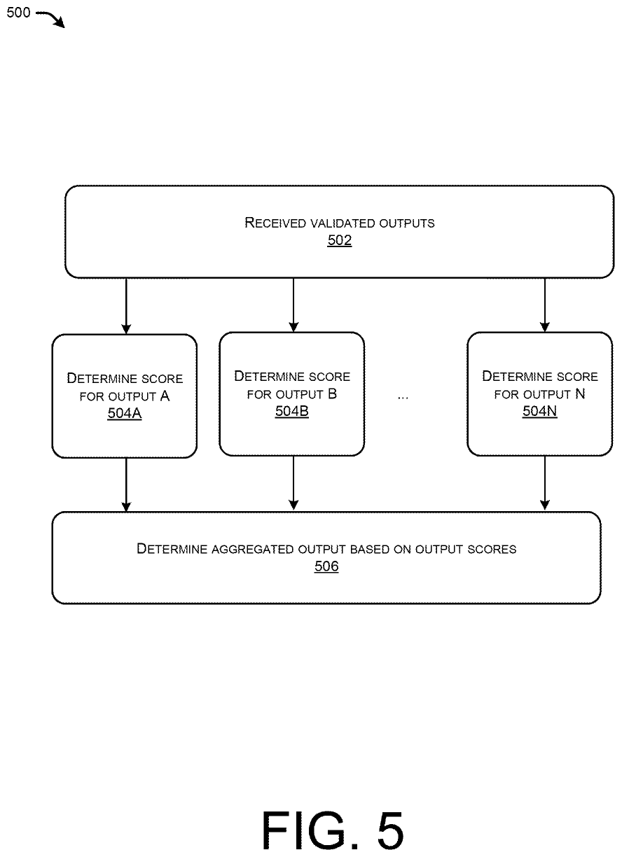

FIG. 5 is a flowchart diagram of an example process 500 for determining an aggregated summarization output based on a set of validated summarization outputs. At operation 502, the system receives a set of N validated summarization outputs. A validated summarization output may be an output of the generative machine learning model via processing a summarization prompt, where the output satisfies one or more output constraints (e.g., one or more output constraints described in the summarization prompt).

At operations 504A-504N, the system determines N scores for the N validated summarization outputs. For example, at operation 504A, the system determines a score for a first validated summarization output; at operation 504B, the system determines a score for a second validated summarization output; and at operation 504N, the system determines a score for an Nth validated summarization output. In some cases, to determine a score for a summarization output, the summarization uses one or more scoring metrics associated with the summarization output.

For example, the system may determine the score associated with the summarization output based on a length-related metric (e.g., a number of tokens and/or words) associated with the summarization output. As another example, the system may determine the score associated with the summarization output based on a metric determined based on a number of alert groups specified in the summarization output (e.g., a ratio of the number of alert groups specified in the output to the number of alert groups associated with the alert logs included in the prompt, a deviation between number of alert groups specified in the output and the number of alert groups associated with the alert logs included in the prompt, and/or the like).

At operation 506, the system determines an aggregated output based on the N scores associated with the N validated summarization outputs. For example, the aggregated output may describe the R outputs having the top R voting scores, where R may be a hyperparameter of the system. As another example, the aggregated output may describe the summarization outputs whose voting scores exceed a threshold T, where T may be a hyperparameter of the system.

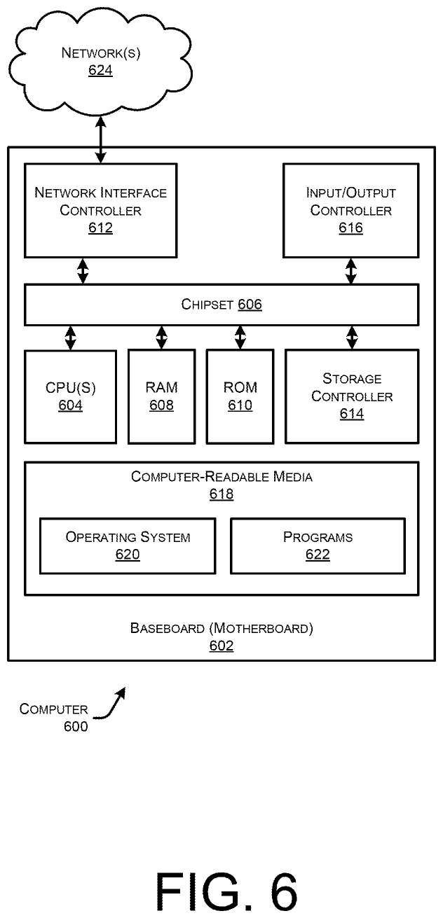

FIG. 6 shows an example computer architecture for a computing device (or network routing device) 600 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein.

The computing device 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computing device 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computing device 600. The chipset 606 can further provide an interface to a computer-readable storage medium such as a read-only memory (“ROM”) 610 or non-volatile RAM (“NVRAM”) for storing basic routines that help to startup the computing device 600 and to transfer information between the various components and devices. The ROM 610 or NVRAM can also store other software components necessary for the operation of the computing device 600 in accordance with the configurations described herein.

The computing device 600 can operate in a networked environment using logical connections to remote computing devices and computer systems through a network 624. The chipset 606 can include functionality for providing network connectivity through a NIC 612, such as a gigabit Ethernet adapter. The NIC 612 is capable of connecting the computing device 600 to other computing devices over the network. It should be appreciated that multiple NICs 612 can be present in the computing device 600, connecting the computer to other types of networks and remote computer systems.

The computing device 600 can be connected to a storage device 618 that provides non-volatile storage for the computing device 600. The storage device 618 can store an operating system 620, programs 622, and data, which have been described in greater detail herein. The storage device 618 can be connected to the computing device 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computing device 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 can further read information from the storage device 618 by detecting the physical states or characteristics of one or more particular locations within the physical storage units.

In addition to the mass storage device 618 described above, the computing device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 600. In some examples, the operations performed by a network, and/or any components included therein (e.g., a router, such as an edge router), may be supported by one or more devices similar to computing device 600. Stated otherwise, some or all of the operations performed by the network, and or any components included therein, may be performed by one or more computing device 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computing device 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computing device 600.

In one embodiment, the storage device 618 or other computer-readable storage media is encoded with computer-executable instructions which, when loaded into the computing device 600, transform the computer from a general-purpose computing system into a special-purpose computer capable of implementing the embodiments described herein. These computer-executable instructions transform the computing device 600 by specifying how the CPUs 604 transition between states, as described above. According to one embodiment, the computing device 600 has access to computer-readable storage media storing computer-executable instructions which, when executed by the computing device 600, perform the various processes described above with regard to FIGS. 1-5. The computing device 600 can also include computer-readable storage media having instructions stored thereupon for performing any of the other computer-implemented operations described herein.

The computing device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computing device 600 might not include all of the components shown in FIG. 6, can include other components that are not explicitly shown in FIG. 6, or might utilize an architecture completely different than that shown in FIG. 6.

The computing device 600 may support a virtualization layer, such as one or more components associated with a computing resource network. The virtualization layer may provide virtual machines or containers that abstract the underlying hardware resources and enable multiple operating systems or applications to run simultaneously on the same physical machine. The virtualization layer may also include components for managing the virtualized resources, such as a hypervisor or virtual machine manager, and may provide network virtualization capabilities, such as virtual switches, routers, or firewalls. By enabling the sharing and efficient utilization of physical resources, virtualization can help reduce costs, simplify management, and increase flexibility in deploying and scaling computing workloads. The computing device 600 may also support other software layers, such as middleware, application frameworks, or databases, that provide additional abstraction and services to application developers and users. In some cases, the computing device 600 may provide a flexible and scalable platform for hosting diverse workloads and applications, from simple web services to complex data analytics and machine learning tasks.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, by a processor, a first alert log and a second alert log associated with a security incident, wherein the first alert log is associated with a first alert group and the second alert log is associated with a second alert group, and wherein the security incident is associated with a computer system;
determining, by the processor and based on the first alert log and the second alert log, a first prompt, wherein the first prompt comprises text data requesting summarization of the first alert log and the second alert log;
determining, by the processor and based on the first alert group and the second alert group, a first count of alert groups associated with the first prompt;
providing, by the processor, the first prompt to a generative machine learning model;
receiving, by the processor, a first model output from the generative machine learning model;
determining, by the processor and based on the first model output, a second count of alert groups associated with the first model output;
determining, by the processor and based on the first count and the second count, that the first model output is valid;
based on determining that the first model output is valid, determining, by the processor, a summary based on the first model output; and
providing, by the processor, the summary using an output interface.

2. The method of claim 1, wherein determining the summary comprises:
providing the first prompt to a generative machine learning model;
receiving a second model output from the generative machine learning model;
determining a third count of alert groups associated with the second model output;
determining, based on the first count and the third count, that the second model output is valid;
based on determining that the second model output is valid, determining a first score associated with the first model output based on a first metric and a second score associated with the second model output; and
determining the summary based on the first score and the second score.

3. The method of claim 2, wherein the first metric represents a count of tokens associated with the first model output.

4. The method of claim 2, wherein the first metric represents a count of hostnames associated with the first model output.

5. The method of claim 2, wherein the first metric represents a count of network addresses associated with the first model output.

6. The method of claim 2, wherein:
the first prompt specifies a structure, and
the first metric represents a count of tokens associated with a first segment of the first model output as defined by the structure.

7. The method of claim 1, wherein determining that the first model output is valid comprises:
determining that the first model output is valid based on a third count of alert logs associated with the first alert group in the first prompt and a fourth count of alert logs associated with the first alert group in the first model output.

8. The method of claim 1, wherein determining that the first model output is valid comprises:
determining a first structure specified by the first prompt;
determining a second structure associated with the first model output; and
determining whether the first structure corresponds to the second structure.

9. The method of claim 1, wherein determining that the first model output is valid comprises:
determining a third count of hostnames associated with the first prompt;
determining a fourth count of hostnames associated with the first model output; and
determining whether the third count matches the fourth count.

10. The method of claim 1, wherein determining that the first model output is valid comprises:
determining a third count of network addresses associated with the first prompt;
determining a fourth count of network addresses associated with the first model output; and
determining whether the third count matches the fourth count.

11. A system comprising:
one or more processors; and
one or more computer-readable media storing computer-executable instructions that, when executed by the one or more processors, cause the one or more processors to perform operations comprising:
receiving a first alert log and a second alert log associated with a security incident, wherein the first alert log is associated with a first alert group and the second alert log is associated with a second alert group, and wherein the security incident is associated with a computer system;
determining, based on the first alert log and the second alert log, a first prompt, wherein the first prompt comprises text data requesting summarization of the first alert log and the second alert log;
determining, based on the first alert group and the second alert group, a first count of alert groups associated with the first prompt;
providing the first prompt to a generative machine learning model;
receiving a first model output from the generative machine learning model;
determining, based on the first model output, a second count of alert groups associated with the first model output;
determining, based on the first count and the second count, that the first model output is valid;
based on determining that the first model output is valid, determining a summary based on the first model output; and
providing the summary using an output interface.

12. The system of claim 11, wherein determining the summary comprises:
providing the first prompt to a generative machine learning model;
receiving a second model output from the generative machine learning model;
determining a third count of alert groups associated with the second model output;
determining, based on the first count and the third count, that the second model output is valid;
based on determining that the second model output is valid, determining a first score associated with the first model output based on a first metric and a second score associated with the second model output; and
determining the summary based on the first score and the second score.

13. The system of claim 12, wherein the first metric represents a count of tokens associated with the first model output.

14. The system of claim 12, wherein the first metric represents a count of hostnames associated with the first model output.

15. The system of claim 12, wherein the first metric represents a count of network addresses associated with the first model output.

16. One or more non-transitory computer-readable media storing computer-executable instructions that, when executed by one or more processors, cause the one or more processors to perform operations comprising:
receiving a first alert log and a second alert log associated with a security incident, wherein the first alert log is associated with a first alert group and the second alert log is associated with a second alert group, and wherein the security incident is associated with a computer system;
determining, based on the first alert log and the second alert log, a first prompt, wherein the first prompt comprises text data requesting summarization of the first alert log and the second alert log;
determining, based on the first alert group and the second alert group, a first count of alert groups associated with the first prompt;
providing the first prompt to a generative machine learning model;
receiving a first model output from the generative machine learning model;
determining, based on the first model output, a second count of alert groups associated with the first model output;
determining, based on the first count and the second count, that the first model output is valid;
based on determining that the first model output is valid, determining a summary based on the first model output; and
providing the summary using an output interface.

17. The one or more non-transitory computer-readable media of claim 16, wherein determining the summary comprises:
providing the first prompt to a generative machine learning model;
receiving a second model output from the generative machine learning model;
determining a third count of alert groups associated with the second model output;
determining, based on the first count and the third count, that the second model output is valid;
based on determining that the second model output is valid, determining a first score associated with the first model output based on a first metric and a second score associated with the second model output; and
determining the summary based on the first score and the second score.

18. The one or more non-transitory computer-readable media of claim 17, wherein the first metric represents a count of tokens associated with the first model output.

19. The one or more non-transitory computer-readable media of claim 17, wherein the first metric represents a count of hostnames associated with the first model output.

20. The one or more non-transitory computer-readable media of claim 17, wherein the first metric represents a count of network addresses associated with the first model output.
